(19) United States
(12) Patent Application Publication
(10) Pub. No.: US 2004/0056475 A1
(43) Pub. Date: Mar. 25, 2004

(54) Invoice

(76) Inventors: Kazutaka Nanbu, Kyoto-shi (JP); Takayasu Kumakawa, Kyoto-shi (JP); Kazuya Yamazaki, Kyoto-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/451,148

(22) PCT Filed: Dec. 14, 2001
(86) PCT No.: PCT/JP01/10996

(30) Foreign Application Priority Data
Dec. 27, 2000 (JP) 2000-399069

(51) Int. Cl. B42D 15/00

(52) U.S. Cl. 283/60.1

(57) ABSTRACT

An invoice 11 is formed such that a sales voucher 13 which can be exchanged with a ticket or a gift certificate, a receipt 15 for the amount of COD to be given to a consumer (receiver) at the time of collecting the money, and a credit slip and an arrival stub 17, which is brought back by a home delivery agent at the time of collecting the money, are detachably integrated on one sheet of paper 19, and is printed by, for example, a laser printer.

### TECHNICAL FIELD

The present invention relates to an invoice for delivering a sales voucher to a receiver's address and more specifically, relates to an invoice in which the sales voucher, a receipt and an arrival stub are integrated on one sheet of paper.

### BACKGROUND ART

An invoice printed separately from the sales voucher has been heretofore attached, in order to deliver the sales voucher such as a ticket to the receiver's address.

Specifically, the invoice comprising the address and name of the receiver printed thereon is adhered on the upper face of an envelope, a transfer form for deferring the payment and a sales voucher such as a ticket are enclosed in this envelope to compose a package, and a home delivery agent collects this package, to deliver it to the receiver.

As described above, the operation for composing a package by putting together the transfer form, the sales voucher and the envelope, which are separate bodies, and adhering the invoice thereon has been heretofore required. Therefore, there is a problem in that the working hour and labor for composing the package are required.

Moreover, after having received the package, the receiver needs to make payment by bringing the transfer form and cash to a banking facility or a convenience store.

### DISCLOSURE OF THE INVENTION

In view of the above situation, it is an object of the present invention to provide a invoice, which can considerably reduce the working load for packaging, and can add credibility to the sales voucher.

The essential point of the present invention is that a sales voucher, a receipt and an arrival stub are detachably integrated on one sheet of paper.

Moreover, the essential point of the present invention is that a sales voucher which can be exchanged with a ticket or a gift certificate, a receipt to be given to a consumer at the time of collecting the money, and an arrival stub, which is brought back by the home delivery agent at the time of collecting the money, are detachably integrated on one sheet of paper.

It is another essential point of the present invention that the paper is for printing predetermined common printing contents by using a plurality of light and dark colors, on which it is also possible to print an individual printing content by using at least one color.

It is another essential point of the present invention that the sales voucher has a watermark of a predetermined shape on the paper.

### BRIEF DESCRIPTION OF THE DRAWINGS

FIG. 1 is a plan view showing the overall configuration of an invoice 11 according to one embodiment of the present invention.

FIG. 2 is a plan view showing a sales voucher 13 in the invoice 11.

FIG. 3 is a plan view showing a receipt 15 for the amount of COD (Cash On Delivery) in the invoice 11.

FIG. 4 is a plan view showing a credit slip and arrival stub 17 in the invoice 11.

### BEST MODES FOR CARRYING OUT THE INVENTION

In order to describe the present invention in more detail, the present invention will be described with reference to the accompanying drawings.

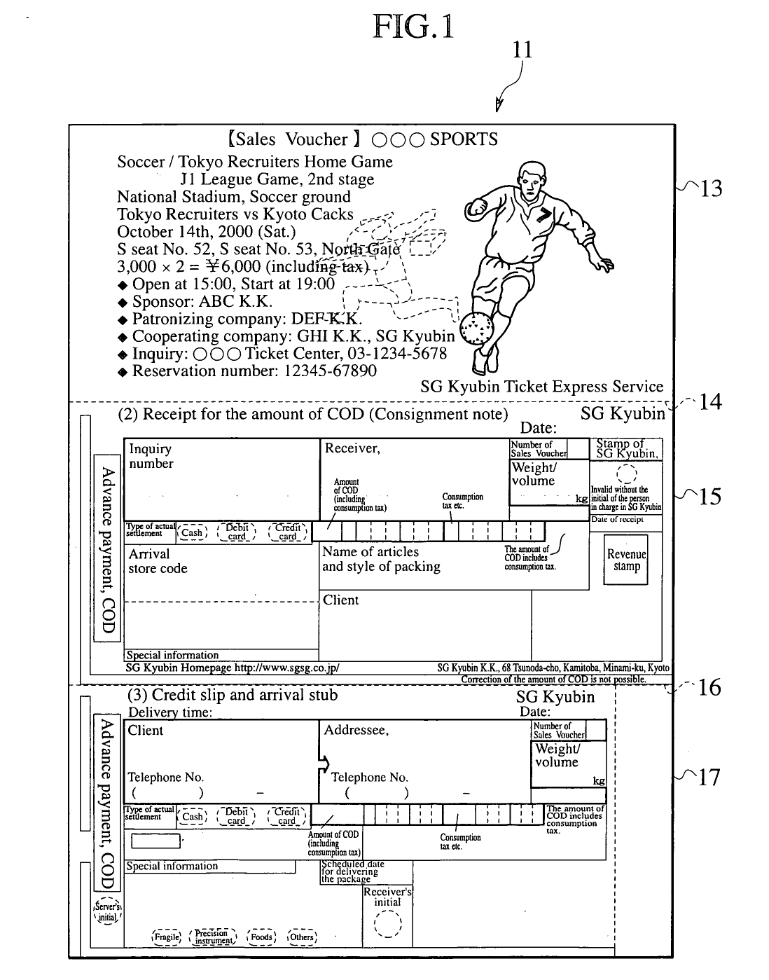

FIG. 1 is a plan view showing the overall configuration of an invoice 11 according to one embodiment of the present invention.

As shown in FIG. 1, the invoice 11 comprises a sales voucher 13 to be exchanged with a ticket or a gift certificate, a receipt 15 for the amount of COD to be given to a consumer at the time of collecting the money, and a credit slip and arrival stub 17, which is brought back by the home delivery agent at the time of collecting the money, which are detachably integrated on one sheet of paper 19, and for example, is printed by a laser printer.

On the paper (form) used for the invoice 11, predetermined common printing contents are printed by using a plurality of light and dark colors, and it is also possible to print an individual printing content by using at least one color thereon. The sales voucher 13 has a watermark of a predetermined character 21 (shape) on the paper.

The invoice 11 also has a perforated line 14 between the sales voucher 13 and the receipt 15 for the amount of COD, and a perforated line 16 between the receipt 15 for the amount of COD and the credit slip and arrival stub 17, which are integrated so as to be detachable.

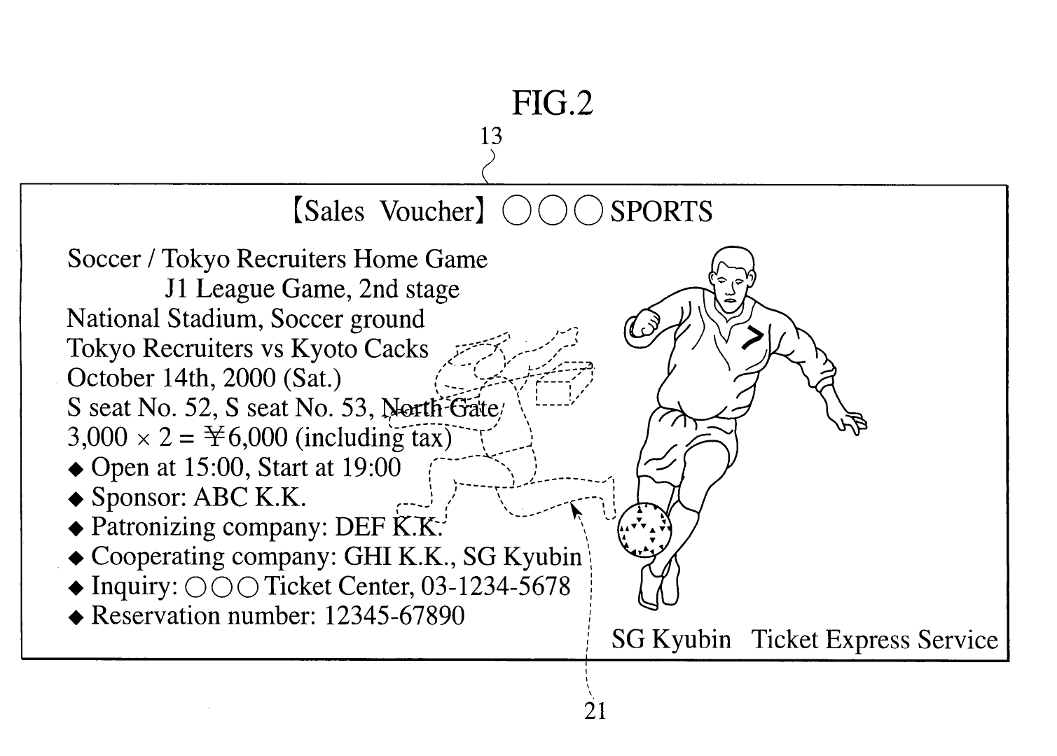

FIG. 2 to FIG. 4 are plan views respectively showing the sales voucher 13, the receipt 15 for the amount of COD and the credit slip and arrival stub 17, as the configuration of the invoice 11 shown in FIG. 1.

More specifically, as shown in FIG. 2, the sales voucher 13 is for example an exchange ticket for a ticket, on which a game content, stadium, the date and time for the game, a seat number, a sponsor, a patronizing company, a cooperating company, inquiry, a reservation number, the name of the home delivery agent, and a service name, as well as an illustration expressing the game content are printed. This sales voucher 13 is handed over to a consumer by cash on delivery (COD).

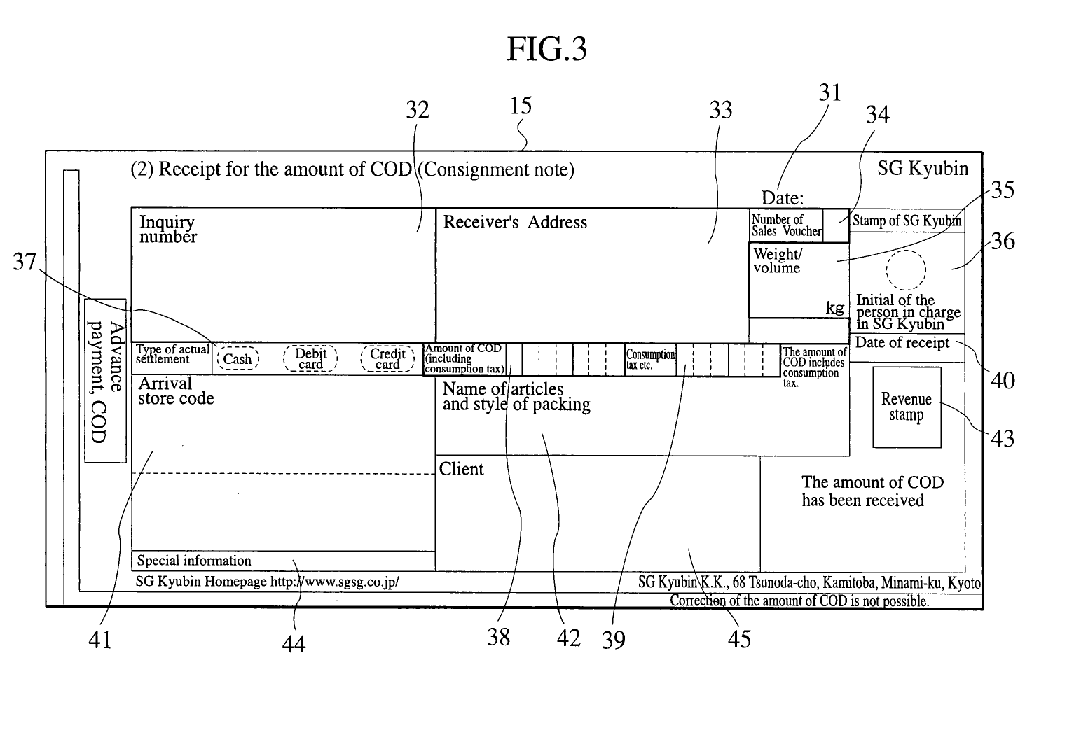

As shown in FIG. 3, in the receipt 15 for the amount of COD, the name of the home delivery agent, a column for printing the date, Advance payment COD, an URL address as the reference for the Internet package, and the name and address of the home delivery agent are written outside of a ruled line.

On the upper row within the ruled line, there are a column 32 for printing the inquiry number, a column 33 for printing a receiver's address and name, a column 34 for printing the number of sales vouchers to be delivered on one occasion, a column 35 for printing the weight/volume of the sales vouchers to be delivered on one occasion, a column 36 for putting a receiver's initial, a column 37 for writing the type of actual settlement (e.g. cash, debit card, credit card), a column 38 for printing the amount of COD including the consumption tax, a column 39 for printing the consumption tax and the like, a column 40 for printing the date of receipt, a column 41 for printing an arrival store code, a column 42 for printing the name of articles and style of packing, a column 43 for adhering a revenue stamp, a column 44 for printing special information, and a column 45 for printing the name, address and telephone number of a branch of the client, and the content of stipulation is also written. This receipt 15 for the amount of COD is handed over to the consumer together with the sales voucher 13, by cash on delivery.

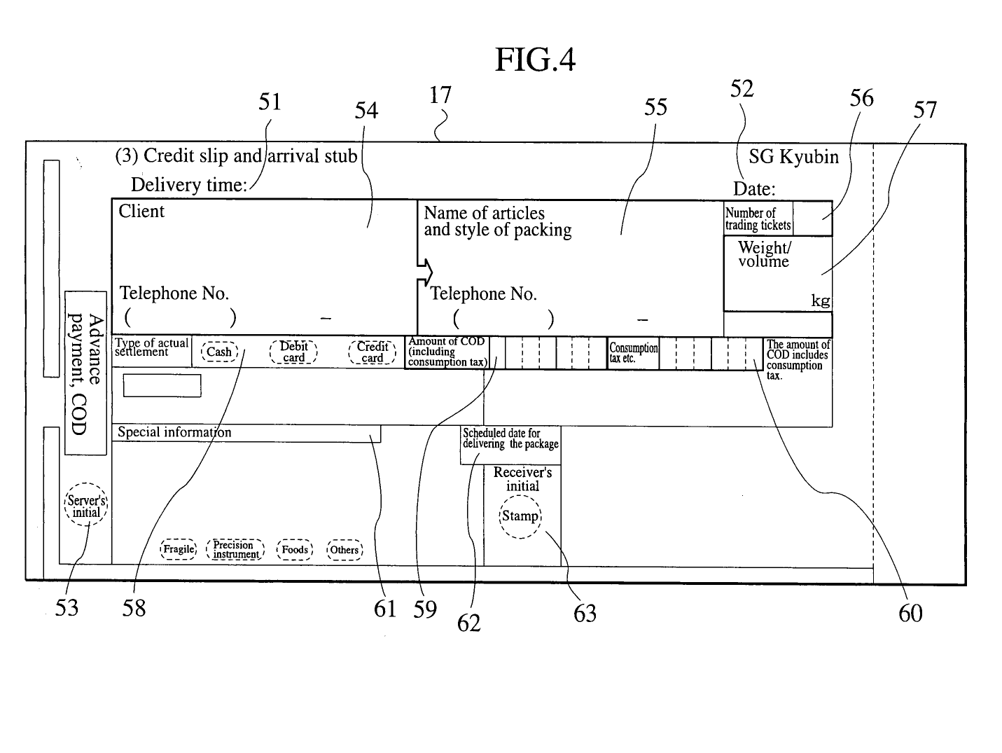

Moreover, as shown in FIG. 4, the credit slip and arrival stub 17 includes, outside of a ruled line, a column 51 for writing the delivery time, a column 52 for printing the date, and Advance payment COD, a column 53 for putting a server's initial.

On the upper row within the ruled line, there are a column 54 for printing the name, address and telephone number of a client, a column 55 for printing the name, address and telephone number of a receiver, a column 56 for printing the number of sales vouchers to be delivered on one occasion, a column 57 for printing the weight/volume of the sales vouchers to be delivered on one occasion, a column 58 for writing the type of actual settlement, such as cash, debit card and credit card, a column 59 for printing the amount of COD including the consumption tax, a column 60 for printing the consumption tax and the like, a column 61 for printing special information, a column 62 for printing the scheduled date for delivering the package, and a column 63 for putting a receiver's initial, as well as remarks printed thereon. This credit slip and arrival stub 17 is brought back by the home delivery agent to the sales office after having been signed by the consumer.

An example of use of the invoice 11 according to the one embodiment of the present invention will be described below.

As described above, on the paper (form) used for the invoice 11, the format of the sales voucher 13, the receipt 15 for the amount of COD and the credit slip and arrival stub 17 are printed as the predetermined common printing contents, by using a plurality of light and dark colors for making it difficult to duplicate the format, and a watermark of a predetermined character (shape) is provided in the sales voucher 13.

For preventing illegal copy, even if a third party duplicates the invoice 11 by using a general popular copying machine, scanner and color printer, since the above-described format is printed in advance on the invoice 11, using a plurality of light and dark colors, and a sheet of paper (form) having a watermark is used, an invoice having a deteriorated color image quality and without having the watermark can be only obtained. As a result, there is a clear difference between the invoice 11 and the copied result.

At first, the paper (form) for the invoice 11 is stored in a form storage section of, for example, a laser printer (not shown) connected to a computer (not shown) provided in the sales office of a home delivery agent.

The individual delivery information for tickets and gift certificates collected in the database of the computer in the sales office is printed on the paper (form) as the printing content, by using at least one color by the laser printer.

As a result, the invoice 11 in which the sales voucher 13, the receipt 15 for the amount of COD and the credit slip and arrival stub 17 are integrated is printed by the laser printer.

Therefore, a deliverer who has received the invoice 11 in the sales office transports the invoice 11 to, for example, a house corresponding to the address and name of the receiver written in the receipt 15 for the amount of COD, and calls the consumer (receiver) at the front door.

When the consumer (receiver) pays the amount of COD, for example by cash, to the deliverer, after having confirmed the contents of the sales voucher 13 and the amount of COD, the deliverer puts his initial as the person in charge in the home delivery agent on the receipt 15 for the amount of COD, writes the type of actual settlement and the date of receipt, folds the invoice at the perforation line 16 provided between the receipt 15 for the amount of COD and the credit slip and arrival stub 17, cuts off the sales voucher 13 and the receipt 15 for the amount of COD from the invoice 11 and hands it over to the consumer (receiver).

The deliverer asks the consumer (receiver) to sign as the receiver's initial on the credit slip and arrival stub 17, receives the stamped credit slip and arrival stub 17 from the consumer, and brings it back to the sales office.

The deliverer then hands over the credit slip and arrival stub 17 and the received cash to, for example, an operator in the sales office, and stores the received content in the database stored in the computer.

In the above example, the consumer (receiver) pays the amount of COD by cash, but the settlement may be conducted by using a debit card or a credit card of a banking facility or a credit company, with whom the consumer has an agreement for settlement. In this case, the deliverer inserts the card (the debit card or the credit card) into a small portable card reader which the deliverer carries, to read the authentication number, expiring date and the like recorded in the card, inputs the amount of merchandise and the inquiry number of the merchandise, and transmits these information to the host computer provided in the information processing center via a radio communication line, to thereby carry out authentication of the card and settlement by the card.

As a result, the conventional operation such as adhering the invoice on the upper face of the envelope, enclosing the transfer form and the sales voucher such as a ticket to compose a package can be eliminated. Moreover, on the side of the receiver's address, the conventional operation such as making payment by bringing the transfer form and cash to a banking facility or a convenience store, after having received the package, can be eliminated.

The effect in this embodiment will be described below.

At first, by forming the invoice such that the sales voucher, the receipt and the arrival stub are detachably integrated on one sheet of paper, the preparation work of the sales voucher, the receipt and the arrival stub can be conducted at the same time in the sales office of, for example, a home delivery agent, thereby enabling considerable reduction in the working hour and operation cost for packaging.

Moreover, the predetermined common printing contents are printed on the paper, by using a plurality of light and dark colors, on which it is also possible to print an individual printing content by using at least one color. As a result, there can be provided the sales voucher, receipt and arrival stub on which the content of individual merchandise is printed on the paper already printed by using a plurality of light and dark colors, thereby illegal duplication by using for example a color copier by a third party can be made difficult. As a result, credibility can be added to the sales voucher.

Furthermore, since the trading paper has a watermark of a predetermined shape on the paper, illegal duplication by a third party can be made difficult, thereby adding credibility to the sales voucher.

The lead time until the delivery can be reduced by directly receiving the data such as the printing content from the consumer. The COD settlement by the deliverer of the home delivery agent becomes possible, thereby the transfer operation for making the payment by the consumer can be eliminated, and the money can be reliably collected.

### INDUSTRIAL APPLICABILITY

According to the present invention, by forming the invoice such that the sales voucher, the receipt and the arrival stub are detachably integrated on one sheet of paper, the preparation work of the sales voucher, the receipt and the arrival stub can be conducted at the same time, thereby enabling considerable reduction in the working hour and operation cost for packaging.

Moreover, the predetermined common printing contents are printed on the paper, by using a plurality of light and dark colors, on which it is also possible to print an individual printing content by using at least one color. As a result, there can be provided the sales voucher, receipt and arrival stub on which the content of individual merchandise is printed on the paper already printed by using a plurality of light and dark colors, thereby illegal duplication by a third party can be made difficult.

Furthermore, since the sales voucher has a watermark of a predetermined shape on the paper, illegal duplication by a third party can be made difficult, thereby adding credibility to the sales voucher.

As described above, the invoice according to the present invention is useful for considerably reducing the working load for packaging, and adding credibility to the sales voucher, and particularly suitable for delivering a sales voucher to a receiver.

1. An invoice comprising:
a sales voucher part;
a receipt part; and
an arrival stub part wherein
the sales voucher part, the receipt part, and the arrival stub part are detachably integrated on one sheet of paper.

2. An invoice comprising:
a sales voucher part which can be exchanged with a ticket or a gift certificate;
a receipt part to be given to a consumer at the time of collecting the money; and
an arrival stub part, which is brought back by a home delivery agent at the time of collecting the money, wherein
the sales voucher part, the receipt part, and the arrival stub part are detachably integrated on one sheet of paper.

3. An invoice according to claims 1 or 2, wherein predetermined common printing contents are printed on the paper by using shades of a plurality of colors, an individual printing content is printed on the paper by using at least one color.

4. An invoice according to claims 1 or 2, wherein the sales voucher part has a watermark of a predetermined shape on the paper.

5. An invoice according to claims 1 or 2, wherein a perforated line is-provided between the sales voucher and the receipt, and a perforated line is provided between the receipt and the arrival stub.
